(19) United States
(12) Patent Application Publication
(10) Pub. No.: US 2026/0214732 A1
(43) Pub. Date: Jul. 23, 2026

(54) DISTRIBUTED HOTSPOT AS A SERVICE FOR A VEHICLE

(71) Applicant: Charter Communications Operating, LLC, St. Louis, MO (US)

(72) Inventors: Mohit Anand, Centennial, CO (US); Hossam Hmimy, Aurora, CO (US); Inmaculada Carrion Rodrigo, Valley Center, CA (US)

(73) Assignee: Charter Communications Operating, LLC, St. Louis, MO (US)

(21) Appl. No.: 19/034,265

(22) Filed: Jan. 22, 2025

(51) Int. Cl. H04W 76/15; H04W 4/40; H04W 12/00; H04W 48/16; H04W 60/04; H04W 84/12

(52) U.S. Cl. CPC H04W 76/15; H04W 12/009; H04W 48/16; H04W 60/04; H04W 4/40; H04W 84/12

(57) ABSTRACT

Methods and systems for providing distributed hotspot as a service. A method includes registering, by a mobile device with a DHAAS controller, to perform as a DHAAS hotspot, authenticating, by a vehicle proxy in a vehicle, a registered mobile device when the registered mobile device is present in the vehicle, initiating, by the DHAAS controller via the vehicle proxy, the registered mobile device to provide a DHAAS hotspot for the vehicle, and switching, by the DHAAS controller via the vehicle proxy, to another registered mobile device to provide a DHAAS hotspot when a switchover threshold is met or exceeded.

### TECHNICAL FIELD

This disclosure relates to wireless communications. More specifically, a service for enabling and managing hotspot connectivity in a vehicle.

### BACKGROUND

During a trip, there are many instances where WiFi connectivity or other non-cellular connectivity is unavailable. This can be problematic for devices which do not have cellular capabilities and cellular-based devices when they approach a data limiting threshold. One approach to providing connectivity is to enable a hotspot capability on a cellular-based device. The non-cellular-based device, for example, can then access the internet via the hotspot. However, the hotspot capability also has data limiting thresholds and/or the hotspot providing device can run low on power or even lose power.

### SUMMARY

Disclosed is a system and method for providing distributed hotspot as a service. In implementations, a method includes registering, by a mobile device with a DHAAS controller, to perform as a DHAAS hotspot, authenticating, by a vehicle proxy in a vehicle, a registered mobile device when the registered mobile device is present in the vehicle, initiating, by the DHAAS controller via the vehicle proxy, the registered mobile device to provide a DHAAS hotspot for the vehicle, and switching, by the DHAAS controller via the vehicle proxy, to another registered mobile device to provide a DHAAS hotspot when a switchover threshold is met or exceeded.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a distributed hotspot as a service architecture in accordance with the teachings described herein.

FIG. 1A is a diagram of an example of a mobile device in accordance with the teachings described herein.

FIG. 2 is a flowchart of an example method for providing a distributed hotspot as a service in accordance with the teachings described herein.

FIG. 3 is a flowchart of an example method for enabling a distributed hotspot as a service in accordance with the teachings described herein.

FIG. 4 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for enabling a distributed hotspot as a service for a vehicle.

In implementations, individuals and/or users of a cellular or mobile device with a hotspot capability (collectively “hotspot mobile device”) can opt into a distributed hotspot as a service (DHAAS) application and/or platform (collectively “DHASS”). The DHAAS can enable and manage a distributed hotspot functionality across the multiple hotspot mobile devices. That is, the DHAAS can share the collective distributed hotspot functionality across non-cellular-based devices and/or devices needing connectivity (collectively “connectivity needed mobile device”). If opted in to share hotspot connectivity with others for incentives, for example, then the hotspot mobile devices can be used as candidates for hotspot service in a coordinated and balanced fashion.

When one or more of the individuals are passenger(s) in a vehicle, such as but not limited to, a car, train, bus, and/or airplane, the DHAAS can provide WiFi connectivity to connectivity needed mobile devices by enabling the hotspot capability on one or more of the hotspot mobile devices. This allows family members, for example, to automatically use their mobile devices as a hotspot without exhausting data usage as the DHAAS monitors and manages the hotspot mobile device usage. It also allows the individuals and/or users to monetize their mobile devices to provide federated secured hotspot as a service for incentives and/or rewards.

In implementations, the DHASS system can be used to send an alert in the event of an emergency event such as, but not limited to, a stolen vehicle, a stolen vehicle with an abducted child, person, and/or individual. In this instance, the DHAAS system can send a command to the vehicle or device acting as hotspot to send an automatic 911 call to law enforcement. This will enable the stolen car to be retrieved. In implementations, the DHAAS system can receive notification from a law enforcement agency, a device associated the DHAAS system, and/or other systems and determine based on vehicle and mobile device information which vehicle it is and send the command accordingly. In implementations, the DHAAS system can receive notification from a law enforcement agency or similar organization and determine based on vehicle and mobile device information which vehicle it is and send the command accordingly.

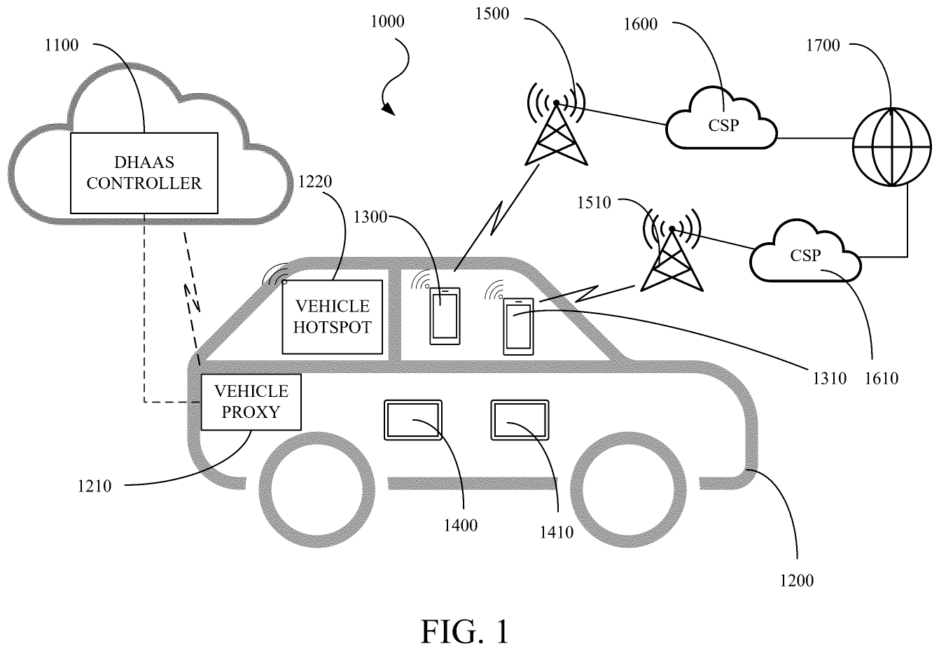

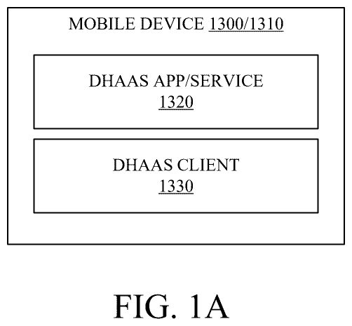

FIG. 1 is a diagram of an example of a DHAAS architecture 1000 in accordance with the teachings described herein. The DHAAS architecture 1000 can include, but is not limited to, a DHAAS controller and/or engine 1100, a vehicle 1200, mobile devices 1300 and 1310, non-cellular-based devices 1400 and 1410, base stations 1500 and 1510, cellular service providers 1600 and 1610, and internet 1700. The number of components shown herein are illustrative and there may be more or less in the DHAAS architecture 1000. The DHAAS architecture 1000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

In implementations, the DHAAS controller and/or engine 1100 can be implemented in a cloud-based platform, in an edge platform, in the vehicle 1200, and/or combinations thereof. The DHAAS controller 1100 can use vehicle cellular connectivity to connect and/or communicate with the vehicle 1200 when the DHAAS controller 1100 is implemented in the cloud-based platform and/or in the edge platform. The DHAAS controller 1100 is carrier agnostic and/or wireless technology agnostic. That is, the DHAAS controller 1100 can work with mobile devices irrespective of the carrier or of the type of wireless technology, which can include, but is not limited to, third generation (3G), fourth generation (4G), and fifth generation (5G) wireless communications and/or networks, and CBRS or shared spectrum wireless technologies and/or networks. The DHAAS controller 1100 can collect and store mobile device information for mobile devices registering with and/or opting into the DHAAS. The mobile device information can include, but is not limited to, carrier information, data plan, data usage (each and/or every time the mobile device is to be used as hotspot), mobile device operating system (OS), modem information, mobile device WiFi supported standards and bands, power connection, battery level, signal strength, data speed, location, and/or user designated offloading and/or switching parameters. The user designated offloading parameters can include, but is not limited to, maximum speed, priority, limit of data usage allowed, and/or offloading and/or switching parameters thresholds. The offloading thresholds can include, but is not limited to, a battery level threshold and/or a data usage threshold, each designating a threshold where hotspot functionality is to be disabled. The DHAAS controller 1100 can monitor and maintain a balanced distributed hotspot based on the collected mobile device information, data usage levels, battery levels, offloading thresholds, defined and/or default mobile device thresholds, and/or other criteria. In implementations, the defined and/or default mobile device thresholds can be, but is not limited to, default data usage threshold and/or battery level threshold.

In implementations, the DHAAS controller 1100 can maintain different thresholds for each parameter. For example, if the mobile device currently providing a hotspot has a battery level that goes to a level A (say 30%) then the DHAAS controller 1100 can send an alert to the user that the battery is going low and that the user should charge the mobile device. If the battery level then goes to a level B (say 25%), then the DHAAS controller 1100 can send a command to disable the hotspot from this mobile device and switch over to another mobile device. If another mobile device is unavailable to act as a hotspot, the DHAAS controller 1100 can alert the non-cellular devices and/or other devices using the hotspot that the hotspot will be disabled.

In implementations, the vehicle 1200 can include, but is not limited to, a vehicle proxy 1210 and a vehicle hotspot device 1220, which communicates with the vehicle proxy 1210. In implementations, the vehicle proxy 1210 can be installed in vehicles that are managed and secured by the DHAAS. The vehicle proxy 1210 can communicate with the mobile devices 1300 and 1310 and the DHAAS controller 1100. In implementations, the vehicle proxy 1210 can be an interface for and/or act on behalf of the mobile devices 1300 and 1310 with the DHAAS controller 1100. In implementations, the vehicle proxy 1210 can authenticate mobile devices which are within the vehicle 1200 and registered with the DHAAS. In implementations, the vehicle proxy 1210 can use location and/or other techniques to determine if a mobile device is within a vehicle to prevent and/or mitigate inadvertent use of the mobile device as a hotspot when the mobile device is not actually in the vehicle. The vehicle hotspot device 1220 is the hotspot functionality of the vehicle 1200 and uses the vehicle cellular connectivity. In implementations, the vehicle hotspot device 1220 can be the primary and/or highest priority hotspot with respect to hotspots which can be provided by the hotspot mobile devices.

In implementations, the mobile devices 1300 and 1310 can work with any type of wireless technology, which can include, but is not limited to, third generation (3G), fourth generation (4G), and fifth generation (5G) wireless communications and/or networks, and CBRS or shared spectrum wireless technologies and/or networks. In implementations, the mobile devices 1300 and 1310 can be, but is not limited to, end user devices, cellular telephones, Internet Protocol(IP) devices, mobile computers, laptops, handheld computers, personal media devices, smartphones, notebooks, notepads, and the like which can be provisioned for operation with a cellular service provider, such as the cellular service providers 1600 and 1610, respectively, via base stations such as the base stations 1500 and 1510, respectively, to access and/or connect to the internet 1700.

Reference is now made also to FIG. 1A, which is a diagram of an example of the mobile devices 1300 and/or 1310 in accordance with the teachings described herein. In implementations, the mobile devices 1300 and/or 1310 can include a DHAAS application and/or service 1320 which a user can use to opt-in into the DHAAS. In the event the user opts-in to the DHAAS, the DHAAS controller 1100 can send and install a client 1330 in the mobile devices 1300 and/or 1310 that will securely communicate with the DHAAS controller 1100 and the vehicle proxy 1210.

In implementations, the non-cellular-based devices 1400 and 1410 can be, but is not limited to, end user devices, cellular telephones, Internet Protocol(IP) devices, mobile computers, laptops, handheld computers, personal media devices, smartphones, notebooks, notepads, and the like which are not configured for cellular connectivity but are configured for non-cellular connectivity such as, but not limited to, WiFi connectivity.

In implementations, the base stations 1500 and 1510 can be an access point, an access node, or like device which enables radio communications access between the mobile devices 1300 and/or 1310 and other devices and/or the internet 1700.

In implementations, the cellular service providers 1600 and 1610 can provide and/or enable wireless connectivity using any type of wireless technology, which can include, but is not limited to, third generation (3G), fourth generation (4G), and fifth generation (5G) wireless communications and/or networks, and CBRS or shared spectrum wireless technologies and/or networks. In implementations, the cellular service providers 1600 and 1610 are different wireless technologies.

The DHAAS and/or DHAAS system can include the DHAAS controller and/or engine 1100, the vehicle proxy 1210, the DHAAS app and/or service 1320, and clients on mobile devices, such as the DHAAS client 1330 on mobile devices 1300 and/or 1310.

Operably, the user and/or owner (collectively “user”) of a mobile device (e.g., mobile devices 1300 and/or 1310) can opt-in to the DHAAS by accepting the terms and conditions and registering with the DHAAS controller 1100 via the DHAAS app 1320. As noted, the DHAAS controller 1100 can send and install a client in the mobile device that will securely communicate with the DHAAS controller 1100 and the vehicle proxy 1210. In implementations, the user can select and/or set one or more offloading parameters and/or policies for the offloading and/or use of the hotspot functionality. The registered mobile device can enable the DHAAS controller 1100 to access, e.g. via APIs, the mobile device information from the mobile device. The DHAAS controller 1100 can obtain updated mobile device information each time the mobile device is enabled as a hotspot using the DHAAS. The DHAAS controller 1100, via API, can establish a secure WiFi service set identifier (SSID) that can be used by other mobile devices. This secure WiFi SSID will only be enabled and broadcast when the mobile device, acting as hotspot, is in the eligible vehicle as authenticated and verified by the vehicle proxy 1210.

The vehicle proxy 1210 can authenticate and verify the presence of mobile devices that are participating in the DHAAS. In accordance with user preferences (i.e., the user designated offloading parameters), the vehicle proxy 1210 can enable one or more of the mobile devices in the vehicle to broadcast the secure WiFi SSID. In implementations, more than one mobile device may be needed to provide wireless coverage in the vehicle. The DHAAS controller 1100 can push portions of the mobile device information such as the user designated offloading parameters, the defined and/or default mobile device thresholds, and/or other information rules and/or policies to the vehicle proxy 1210. In implementations, non-cellular devices can register with the vehicle proxy 1210 to enable access to the WiFi SSID. This enables the vehicle proxy 1210 to keep track of which non-cellular devices are in the vehicle and are using the hotspot provided via the DHAAS.

The DHAAS controller 1100, via the vehicle proxy 1210, can obtain updated mobile device information such as the data usage during the hotspot session. The DHAAS controller 1100 can maintain mobile device information and updates thereof for all the mobile devices in the vehicle that are participating in the DHAAS. The participating mobile devices can be obtained from the vehicle proxy 1210. This can enable the DHAAS controller 1100 to apply a distributed and balanced procedure and switch between the mobile devices as described herein.

Initially, the DHAAS controller 1100 can prioritize usage of the vehicle hotspot device 1220 to provide hotshot coverage in the vehicle 1200. In implementations, the DHAAS controller 1100 can enable one or more mobile devices to provide additional hotspot coverage if the hotspot coverage provided by the vehicle hotspot device 1220 is insufficient. This can be based on signal strength measurements and the like using the mobile devices and/or the vehicle proxy 1210.

The DHAAS controller 1100 can monitor the data usage on the hotspot(s) and apply the rules and/or policies based on the mobile device information for each of the mobile devices and the vehicle hotspot. Upon meeting and/or exceeding the criteria to switch from one or more of the hotspots (i.e., based on usage time, data usage, battery level reached, etc.), then the DHAAS controller 1100 can send a command to the mobile devices and/or the vehicle proxy 1210 providing the hotspot(s) to disconnect and send a command to other mobile devices in the vehicle 1200 to enable the hotspot functionality and act as hotspot(s). This can be referred to as hotspot switch over. The DHAAS controller 1100 can orchestrate and switch over between different mobile devices in the vehicle 1200 to load balance between hotspots. The DHAAS controller 1100 can load balance the devices (e.g., non-cellular devices or data limited cellular devices that are using the hotspots) between multiple hotspots, if appropriate.

In implementations, there can be multiple mobile devices which can provide and/or act as a hotspot. In these instances, the DHAAS controller 1100 can determine which of the mobile devices to switch to depending on which mobile device has highest data usage availability, highest battery level, latest WiFi standard and/or specification, and/or combinations thereof. In a non-limiting illustration, the DHAAS controller 1100 can select a mobile device with the most current Wi-Fi support or specifications so that the hotspot is enabling data access at higher speeds using a Wi-Fi 7 capable device as compared to a Wi-Fi 5 capable device, for example. In implementations, each of the criteria can be weighted and each mobile device prioritized based on a weighted combination. For example, higher weights can be given to higher WiFi capable devices, mobile devices having more than a defined threshold of battery level, mobile devices having more than a defined threshold of data usage available, and/or combinations thereof.

In implementations, the DHAAS controller 1100 can optimize hotspot usage by proactively terminating connections of connected devices (e.g., non-cellular devices or data limited cellular devices) that are not actively using the hotspot(s).

As noted, the DHAAS controller 1100 can monitor and calculate data usage for each mobile device that is actively providing a hotspot. The DHAAS controller 1100 can calculate the data usage for each mobile device and subtract the data usage from the up-to-date data usage that was communicated to the DHAAS controller 1100 prior to the start of the hotspot session. The calculated and/or resultant data usage can be compared to the thresholds in the rules and/or policies to trigger end of the hotspot session(s) and/or switch overs, as appropriate.

Upon completion of the hotspot session, the DHAAS controller 1100 can request, via an API, updated data usage from a service provider to compare and reconcile with the calculated data usage.

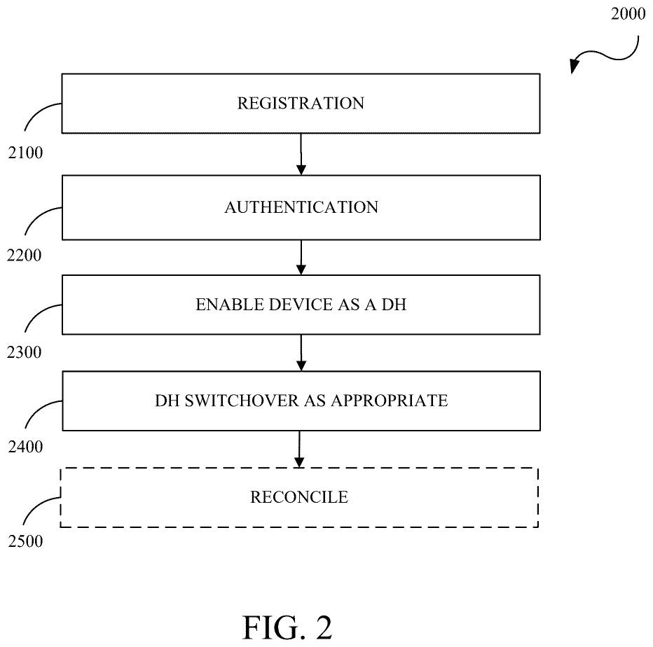

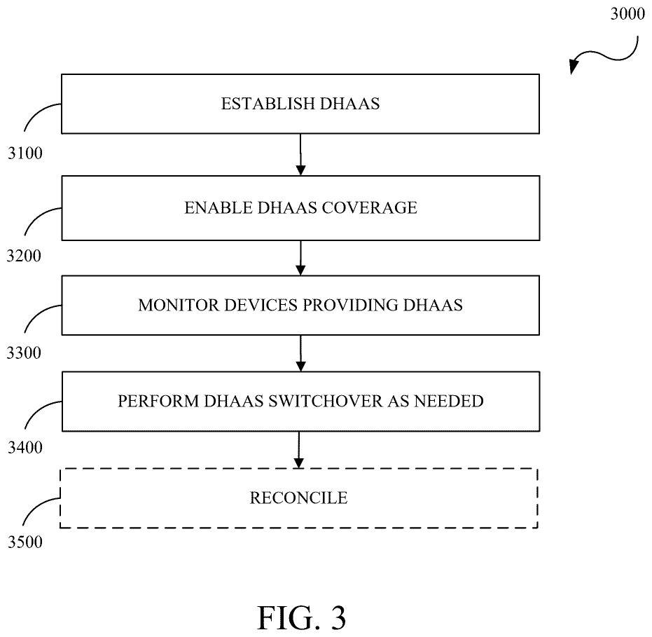

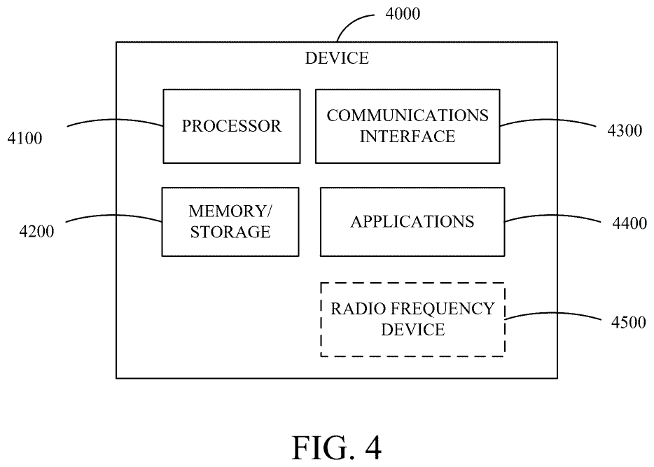

FIG. 2 is a flowchart of an example method 2000 for providing a distributed hotspot as a service in accordance with the teachings described herein. The method 2000 includes: registering 2100 to perform as and access a DHAAS hotspot; authenticating 2200 a mobile device is registered with DHAAS when the mobile device is present in a vehicle; commanding 2300 a DHAAS hotspot for a hotspot session for the vehicle; switching 2400 which mobile devices provide DHAAS hotspots during the hotspot session as needed; and reconciling 2500 data usage upon hotspot session termination. The method 2000 can be implemented, for example, in or by components described with respect to FIGS. 1, 1A, and 4 and in conjunction with any of the flows described with respect to FIG. 3, as appropriate and applicable.

The method 2000 includes registering 2100 to perform as and access a DHAAS hotspot. Users of mobile devices can register with DHAAS to enable DHAAS to use the mobile device as a DHAAS hotspot and permit the mobile device to use DHAAS hotspots. Incentives can be provided to users in the form of additional data usage time, discounts, access to premium services, and/or other rewards. Registration can be accomplished using a DHAAS application, online, and/or other methods. A DHAAS controller can push a DHAAS client to the mobile device upon registration. The DHAAS controller can obtain the mobile device information to enable and/or execute DHAAS with respect to the mobile device. The DHAAS controller can send the mobile device information to vehicle proxies to enable an authentication process.

The method 2000 includes authenticating 2200 a mobile device is registered with DHAAS when the mobile device is present in a vehicle. A vehicle proxy in a vehicle can detect and determine if a DHAAS registered mobile device is present in the vehicle. The vehicle proxy can execute the authentication process to confirm DHAAS registration. The vehicle proxy can relay the presence of DHAAS registered mobile devices to the DHAAS controller.

The method 2000 includes commanding 2300 a DHAAS hotspot for a hotspot session for the vehicle. The DHAAS controller can command, initiate, and/or enable a DHAAS hotspot after receiving presence of the DHAAS registered mobile devices in the vehicle from the vehicle proxy. In implementations, the DHAAS controller initially enables the vehicle hotspot device to provide the DHAAS hotspot. A secure SSID to access the DHAAS hotspot is broadcast by the vehicle hotspot device. The DHAAS controller can enable registered mobile devices to provide DHAAS hotspots depending on sufficiency of the hotspot coverage. The registered mobile devices would broadcast the same SSID. The vehicle proxy can track and/or relay the mobile devices using the DHAAS hotspot(s).

The method 2000 includes switching 2400 which mobile devices provide DHAAS hotspots during the hotspot session as needed. The DHAAS controller can monitor the data usage, power levels, and/or other parameters for a device (e.g., vehicle hotspot device, mobile device, etc.) associated with a given DHAAS hotspot. The DHAAS controller can switch from the vehicle hotpot device and mobile device(s) to other mobile devices if a switchover threshold has been reached, met, and/or exceeded with respect the vehicle hotspot device and/or mobile device(s). The switchover threshold can be a battery level threshold and/or a data usage threshold, for example.

The method 2000 includes reconciling 2500 data usage upon hotspot session termination. The DHAAS controller can reconcile a calculated data usage versus actual data usage once a hotspot session is terminated. The actual data usage can be obtained via the mobile devices and/or from the service providers, as appropriate or applicable.

FIG. 3 is a flowchart of an example method 3000 for enabling a distributed hotspot as a service in accordance with the teachings described herein. The method 3000 includes: establishing 3100 DHAAS service; enabling 3200 DHAAS coverage when a registered mobile device is present in a vehicle; monitoring 3300 registered mobile devices providing DHAAS coverage; performing 3400 DHAAS switchover as needed; and reconciling 3500 data usage upon hotspot session termination. The method 3000 can be implemented, for example, in or by components described with respect to FIGS. 1, 1A, and 4 and in conjunction with any of the flows described with respect to FIG. 2, as appropriate and applicable.

The method 3000 includes establishing 3100 DHAAS service. DHAAS service can be provided by users of mobile devices who have registered with a DHAAS controller via an application and/or online. Incentives can be provided to users as described herein. The DHAAS controller can push a DHAAS client to the mobile device upon registration. The DHAAS controller can obtain the mobile device information to enable and/or execute DHAAS service with respect to the mobile device. The DHAAS controller can send the mobile device information to vehicle proxies for authentication processing.

The method 3000 includes enabling 3200 DHAAS coverage when a registered mobile device is present in a vehicle. A vehicle proxy in a vehicle can determine if a DHAAS registered mobile device is present in the vehicle. The vehicle proxy can execute the authentication process to confirm DHAAS registration. The vehicle proxy can relay the presence of DHAAS registered mobile devices to the DHAAS controller. The DHAAS controller can initiate and/or enable a DHAAS hotspot after receiving presence of the DHAAS registered mobile devices in the vehicle from the vehicle proxy. In implementations, the DHAAS controller initially enables the vehicle hotspot device to provide the DHAAS hotspot. A secure SSID associated with the DHAAS hotspot is broadcast by the vehicle hotspot device. The DHAAS controller can enable further DHAAS hotspots depending on sufficiency of the hotspot coverage. The vehicle proxy can track and/or relay the mobile devices using the DHAAS hotspot(s).

The method 3000 includes monitoring 3300 registered mobile devices providing DHAAS coverage. The DHAAS controller can monitor the data usage, power levels, and/or other parameters for a device (e.g., vehicle hotspot device, mobile device, etc.) associated with a given DHAAS hotspot.

The method 3000 includes performing 3400 DHAAS switchover as needed. The DHAAS controller can switch from the vehicle hotpot device and mobile device(s) to other mobile devices if a switchover threshold has been reached, met, and/or exceeded with respect the vehicle hotspot device and/or mobile device(s). The switchover threshold can be a battery level threshold and/or a data usage threshold, for example.

The method 3000 includes reconciling 3500 data usage upon hotspot session termination. The DHAAS controller can reconcile a calculated data usage versus actual data usage once a hotspot session is terminated. The actual data usage can be obtained via the mobile devices and/or from the service providers, as appropriate or applicable.

FIG. 4 is a block diagram of an example of a device 4000 in accordance with the teachings described herein. The device 4000 may include, but is not limited to, a processor 4100, a memory/storage 4200, a communication interface 4300, applications 4400, and, if needed, a radio frequency device 4500. The device 4000 may include or implement, for example, the systems and components described with respect to FIGS. 1 and 1A and the implement the methods of FIGS. 2 and 3. The applicable or appropriate flows, techniques, or methods described herein may be stored in the memory/storage 4200 and executed by the processor 4100 in cooperation with the memory/storage 4200, the communications interface 4300, the applications 4400, and the radio frequency device 4500 (when applicable), as appropriate. The device 4000 may include other elements which may be desirable or necessary to implement the devices, systems, and methods described herein. However, because such elements and steps do not facilitate a better understanding of the disclosed embodiments, a discussion of such elements and steps may not be provided herein.

Described is a method for providing distributed hotspot as a service. In implementations, a method includes registering, by a mobile device with a DHAAS controller, to perform as a DHAAS hotspot, authenticating, by a vehicle proxy in a vehicle, a registered mobile device when the registered mobile device is present in the vehicle, initiating, by the DHAAS controller via the vehicle proxy, the registered mobile device to provide a DHAAS hotspot for the vehicle, and switching, by the DHAAS controller via the vehicle proxy, to another registered mobile device to provide a DHAAS hotspot when a switchover threshold is met or exceeded.

In implementations, the switchover threshold is a data usage switchover threshold and the method further includes monitoring, by the DHAAS controller via the vehicle proxy, data usage associated with the DHAAS hotspot provided by the registered mobile device to determine if the data usage switchover threshold is met or exceeded. In implementations, the switchover threshold is a battery level switchover threshold and the method further includes monitoring, by the DHAAS controller via the vehicle proxy, a battery level of the registered mobile device to determine if the battery level switchover threshold is met or exceeded. In implementations, the method further includes sending, by the DHAAS controller via the vehicle proxy, an alert to the registered mobile device to charge a battery. In implementations, the initiating further includes initiating, by the DHAAS controller via the vehicle proxy, multiple registered mobile devices to provide multiple DHAAS hotspots so that DHAAS hotspot coverage is provided throughout the vehicle. In implementations, the registering further includes obtaining, by the DHAAS controller, mobile device information from the mobile device. In implementations, the method further includes obtaining, by the DHAAS controller via the vehicle proxy, data usage for the registered mobile device at authentication. In implementations, the switchover threshold is a data usage switchover threshold and wherein the switching further includes obtaining, by the DHAAS controller via the vehicle proxy, data usage for the DHAAS hotspot provided by the registered mobile device, subtracting, by the DHAAS controller, the data usage for the DHAAS hotspot provided by the registered mobile device from the data usage obtained at authentication, and comparing a resultant data usage to the data usage switchover threshold. In implementations, the registering further includes pushing, by the DHAAS controller to the mobile device, a DHAAS client, wherein the DHAAS client communicates with the vehicle proxy. In implementations, the initiating further includes broadcasting, by the registered mobile device, a secure service set identifier (SSID) for accessing the DHAAS hotspot.

Described is a method for providing distributed hotspot as a service. In implementations, the method includes establishing, by a DHAAS controller, a DHAAS service by registering mobile devices which have hotspot capability, enabling, by the DHAAS controller, a DHAAS hotspot via the DHAAS service when a mobile device that is registered with the DHAAS service is present in a vehicle, monitoring, by the DHAAS controller, data usage for the DHAAS hotspot, and performing, by the DHAAS controller, a DHAAS switchover from one mobile device in the DHAAS service to another mobile device in the DHAAS service when a data usage threshold is reached or exceeded based on the data usage.

In implementations, the method further includes detecting, by a vehicle proxy in the vehicle, the mobile device in the vehicle, and authenticating, by the vehicle proxy, that the mobile device is registered with the DHAAS service. In implementations, the method further includes monitoring, by the DHAAS controller, a battery level of the mobile device, and sending, by the DHAAS controller to a mobile device providing the DHAAS hotspot, an alert to charge a battery when a battery level switchover threshold is met or exceeded. In implementations, the method further includes switching, by the DHAAS controller, to a different mobile device in the DHAAS service when the battery level switchover threshold is met or exceeded. In implementations, the enabling further includes enabling, by the DHAAS controller, multiple mobile devices in the DHAAS service to provide multiple DHAAS hotspots to provide DHAAS hotspot coverage throughout the vehicle. In implementations, the performing further includes subtracting, by the DHAAS controller, the data usage for the DHAAS hotspot from data usage obtained at authentication and comparing a resultant data usage to the data usage threshold. In implementations, the enabling further includes broadcasting, by a mobile device in the DHAAS service, a secure service set identifier (SSID) for accessing the DHAAS hotspot.

Described is a system for providing distributed hotspot as a service. In implementations, the system includes a controller configured to register mobile devices to provide hotspot coverage and a vehicle proxy in a vehicle. The vehicle proxy is configured to detect a presence of a mobile device in the vehicle and determine if the mobile device is registered with the controller. The controller is further configured to command the mobile device to operate as a hotspot if the mobile device is registered with the controller, monitor a switchover condition for the mobile device, and switchover to another mobile device registered with the controller and in the vehicle when the switchover condition is met or exceeded.

In implementations, the switchover condition is data usage and the controller is further configured to subtract a data usage for the from data usage at start of the hotspot and compare a resultant data usage to a data usage threshold. In implementations, the controller is further configured to command multiple mobile devices registered with the controller and in the vehicle to operate as hotspots to provide hotspot coverage throughout the vehicle.

Described is a system for providing distributed hotspot as a service. In implementations, the system includes a distributed hotspot as a service (DHAAS) controller. The DHAAS configured to establish a DHAAS service by registering mobile devices which have hotspot capability, enable, a DHAAS hotspot via the DHAAS service when a mobile device that is registered with the DHAAS service is present in a vehicle, monitor data usage for the DHAAS hotspot, and perform, a DHAAS switchover from one mobile device in the DHAAS service to another mobile device in the DHAAS service when a data usage threshold is reached or exceeded based on the data usage.

In implementations, the DHAAS controller further configured to monitor a battery level of the mobile device, send to a mobile device providing the DHAAS hotspot, an alert to charge a battery when a battery level switchover threshold is met or exceeded, and switch to a different mobile device in the DHAAS service when the battery level switchover threshold is met or exceeded. In implementations, the DHAAS controller further configured to enable multiple mobile devices in the DHAAS service to provide multiple DHAAS hotspots to provide DHAAS hotspot coverage throughout the vehicle.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for providing a distributed hotspot as a service (DHAAS), the method comprising:
registering, by a mobile device with a DHAAS controller, to perform as a DHAAS hotspot;
authenticating, by a vehicle proxy in a vehicle, a registered mobile device when the registered mobile device is present in the vehicle;
initiating, by the DHAAS controller via the vehicle proxy, the registered mobile device to provide a DHAAS hotspot for the vehicle; and
switching, by the DHAAS controller via the vehicle proxy, to another registered mobile device to provide a DHAAS hotspot when a switchover threshold is met or exceeded.

2. The method of claim 1, wherein the switchover threshold is a data usage switchover threshold and the method further comprising:
monitoring, by the DHAAS controller via the vehicle proxy, data usage associated with the DHAAS hotspot provided by the registered mobile device to determine if the data usage switchover threshold is met or exceeded.

3. The method of claim 1, wherein the switchover threshold is a battery level switchover threshold and the method further comprising:
monitoring, by the DHAAS controller via the vehicle proxy, a battery level of the registered mobile device to determine if the battery level switchover threshold is met or exceeded.

4. The method of claim 3, further comprising:
sending, by the DHAAS controller via the vehicle proxy, an alert to the registered mobile device to charge a battery.

5. The method of claim 1, wherein the initiating further comprising:
initiating, by the DHAAS controller via the vehicle proxy, multiple registered mobile devices to provide multiple DHAAS hotspots so that DHAAS hotspot coverage is provided throughout the vehicle.

6. The method of claim 1, wherein the registering further comprising:
obtaining, by the DHAAS controller, mobile device information from the mobile device.

7. The method of claim 1, further comprising:
obtaining, by the DHAAS controller via the vehicle proxy, data usage for the registered mobile device at authentication.

8. The method of claim 7, wherein the switchover threshold is a data usage switchover threshold and wherein the switching further comprising:
obtaining, by the DHAAS controller via the vehicle proxy, data usage for the DHAAS hotspot provided by the registered mobile device;
subtracting, by the DHAAS controller, the data usage for the DHAAS hotspot provided by the registered mobile device from the data usage obtained at authentication; and
comparing a resultant data usage to the data usage switchover threshold.

9. The method of claim 1, wherein the registering further comprising:
pushing, by the DHAAS controller to the mobile device, a DHAAS client, wherein the DHAAS client communicates with the vehicle proxy.

10. The method of claim 1, wherein the initiating further comprising:
broadcasting, by the registered mobile device, a secure service set identifier (SSID) for accessing the DHAAS hotspot.

11. A method for distributed hotspot as a service (DHAAS), the method comprising:
establishing, by a DHAAS controller, a DHAAS service by registering mobile devices which have hotspot capability;
enabling, by the DHAAS controller, a DHAAS hotspot via the DHAAS service when a mobile device that is registered with the DHAAS service is present in a vehicle;
monitoring, by the DHAAS controller, data usage for the DHAAS hotspot; and
performing, by the DHAAS controller, a DHAAS switchover from one mobile device in the DHAAS service to another mobile device in the DHAAS service when a data usage threshold is reached or exceeded based on the data usage.

12. The method of claim 11, further comprising:
detecting, by a vehicle proxy in the vehicle, the mobile device in the vehicle; and
authenticating, by the vehicle proxy, that the mobile device is registered with the DHAAS service.

13. The method of claim 11, further comprising:
monitoring, by the DHAAS controller, a battery level of the mobile device; and
sending, by the DHAAS controller to a mobile device providing the DHAAS hotspot, an alert to charge a battery when a battery level switchover threshold is met or exceeded.

14. The method of claim 13, further comprising:
switching, by the DHAAS controller, to a different mobile device in the DHAAS service when the battery level switchover threshold is met or exceeded.

15. The method of claim 11, wherein the enabling further comprising:
enabling, by the DHAAS controller, multiple mobile devices in the DHAAS service to provide multiple DHAAS hotspots to provide DHAAS hotspot coverage throughout the vehicle.

16. The method of claim 11, wherein the performing further comprising:
subtracting, by the DHAAS controller, the data usage for the DHAAS hotspot from data usage obtained at authentication; and
comparing a resultant data usage to the data usage threshold.

17. The method of claim 11, wherein the enabling further comprising:
broadcasting, by a mobile device in the DHAAS service, a secure service set identifier (SSID) for accessing the DHAAS hotspot.

18. A system, comprising:
a controller configured to register mobile devices to provide hotspot coverage; and
a vehicle proxy in a vehicle, the vehicle proxy configured to:
detect a presence of a mobile device in the vehicle; and
determine if the mobile device is registered with the controller,
wherein the controller is further configured to:
command the mobile device to operate as a hotspot if the mobile device is registered with the controller;
monitor a switchover condition for the mobile device; and
switchover to another mobile device registered with the controller and in the vehicle when the switchover condition is met or exceeded.

19. The system of claim 18, wherein the switchover condition is data usage and the controller further configured to:
subtract a data usage for the from data usage at start of the hotspot; and
compare a resultant data usage to a data usage threshold.

20. The system of claim 18, the controller further configured to:
command multiple mobile devices registered with the controller and in the vehicle to operate as hotspots to provide hotspot coverage throughout the vehicle.

21. A system, comprising:
a distributed hotspot as a service (DHAAS) controller configured to:
establish a DHAAS service by registering mobile devices which have hotspot capability;
enable, a DHAAS hotspot via the DHAAS service when a mobile device that is registered with the DHAAS service is present in a vehicle;
monitor data usage for the DHAAS hotspot; and
perform, a DHAAS switchover from one mobile device in the DHAAS service to another mobile device in the DHAAS service when a data usage threshold is reached or exceeded based on the data usage.

22. The system of claim 21, the DHAAS controller further configured to:
monitor a battery level of the mobile device;
send to a mobile device providing the DHAAS hotspot, an alert to charge a battery when a battery level switchover threshold is met or exceeded; and
switch to a different mobile device in the DHAAS service when the battery level switchover threshold is met or exceeded.

23. The system of claim 21, the DHAAS controller further configured to:
enable multiple mobile devices in the DHAAS service to provide multiple DHAAS hotspots to provide DHAAS hotspot coverage throughout the vehicle.
